(19) United States
(12) Patent Application Publication
(10) Pub. No.: US 2026/0101017 A1
(43) Pub. Date: Apr. 9, 2026

(54) VIDEO RETRIEVAL FROM MULTIPLE VIDEO CAMERAS IN A VIDEO CONFERENCE SPACE

(71) Applicant: Cisco Technology, Inc., San Jose, CA (US)

(72) Inventors: Jochen Christof Schirdewahn, Stabekk (NO); Christian Fjelleng Theien, Asker (NO); Vincent Naveau, Baerums Verk (NO)

(21) Appl. No.: 18/906,841

(22) Filed: Oct. 4, 2024

(51) Int. Cl. H04N 7/14; G06T 7/70; G06V 10/25; H04N 7/15

(52) U.S. Cl. CPC H04N 7/147; G06T 7/70; G06V 10/25; H04N 7/15

(57) ABSTRACT

A video conference room system includes a plurality of video cameras that capture video with different views in a video conference space during a video conference session, and a central control device. The central control device requests from a first one or more video cameras one or more full field of view snapshots of video, or requests a second one or more video cameras to analyze video captured by the second one or more video cameras to determine person identity, pose and position and send metadata representing analysis results to the central control device. The central control device analyzes the one or more of snapshots for person identity, pose and position information or the metadata from the second one or more video cameras, and selects one or more video cameras from which to receive a video stream and decide the area of the image to show to the far end.

### TECHNICAL FIELD

The present disclosure relates to video conference systems.

### BACKGROUND

To achieve a realistic video conference experience, several video cameras are deployed in a video conference room (space). These video cameras allow for capturing multiple views of persons and other activity in the space from different angles. It can be challenging to select the best camera view to represent the activity at a given point during a video conference session in a manner such that a remote participant can follow along in the session as well as if the remote participant were physically attending the meeting in the video conference space.

### BRIEF DESCRIPTION OF THE DRAWINGS

FIG. 1A is a diagram depicting a video conference room system deployed in a video conference space and configured to perform video retrieval and processing techniques for video from multiple video cameras, according to an example embodiment.

FIG. 1B is a diagram depicting an example spatial arrangement of components of a video conference room system in a video conference space, according to an example embodiment.

FIG. 2 illustrates a detailed block diagram of a central control device and video cameras that form a part of the video conference room system shown in FIG. 1A, according to an example embodiment.

FIG. 3 is a high-level flow chart depicting operations performed by the video conference room system, according to an example embodiment.

FIG. 4 is a more detailed flow chart depicting a process according to an example embodiment.

FIGS. 5A and 5B are diagrams of a video conference space showing examples of uses of the techniques presented herein, according to an example embodiment.

### DETAILED DESCRIPTION

### Overview

According to one embodiment, a video conference room system is provided. The system includes a plurality of video cameras configured to capture video with different views in a video conference space during a video conference session, and a central control device configured to be in communication with the plurality of video cameras. The central control device is configured to request from a first one or more video cameras one or more snapshots of video, or request a second one or more video cameras to analyze video captured by the second one or more video cameras to determine person identity, pose and position and send metadata representing analysis results to the central control device. The central control device analyzes the one or more of snapshots for person identity, pose and position information obtained from the first one or more video cameras or the metadata from the second one or more video cameras. The central control device selects one or more video cameras from which to receive a video stream based on the analyzing to generate an output video stream.

In accordance with another embodiment, a method is provided. The method includes capturing video with a plurality of video cameras with different views in a video conference space during a video conference session. The method further includes, at a central control device that is in communication with the plurality of video cameras: requesting from a first one or more video cameras one or more snapshots of video; requesting a second one or more video cameras to analyze video captured by the second one or more video cameras to determine person identity, pose and position and send metadata representing analysis results to the central control device; analyzing the one or more of snapshots for person identity, pose and position information obtained from the first one or more video cameras or the metadata from the second one or more video cameras; and selecting one or more video cameras from which to receive a video stream based on the analyzing to generate an output video stream.

Further still, in accordance with yet another embodiment, an apparatus is provided. The apparatus includes a network interface configured to enable network communication with a plurality of video cameras configured to capture video with different views in a video conference space during a video conference session; a memory; and a processor configured to execute instructions stored in the memory to perform operations including: requesting from a first one or more video cameras one or more snapshots of video; requesting a second one or more video cameras to analyze video captured by the second one or more video cameras to determine person identity, pose and position and send metadata representing analysis results to the apparatus; analyzing the one or more of snapshots for person identity, pose and position information obtained from the first one or more video cameras or the metadata from the second one or more video cameras; and selecting one or more video cameras from which to receive a video stream based on the analyzing to generate an output video stream.

### Example Embodiments

To provide a more realistic video conferencing experience, a plurality of video cameras can be deployed in the video conference space, allowing for multiple views to be captured, from which to select, one or more views that are sent to the far end meeting participants. A video conference room system may employ centralized “director logic” that is provided with, or can generate, metadata related to the persons that are present in the room, their pose information, audio analytics, detected objects in the space (chairs, whiteboards, etc.), based on video captured by video cameras in the room and audio detected by microphones in the room. This can provide a more realistic or “cinematic” experience to participants in a video conference session.

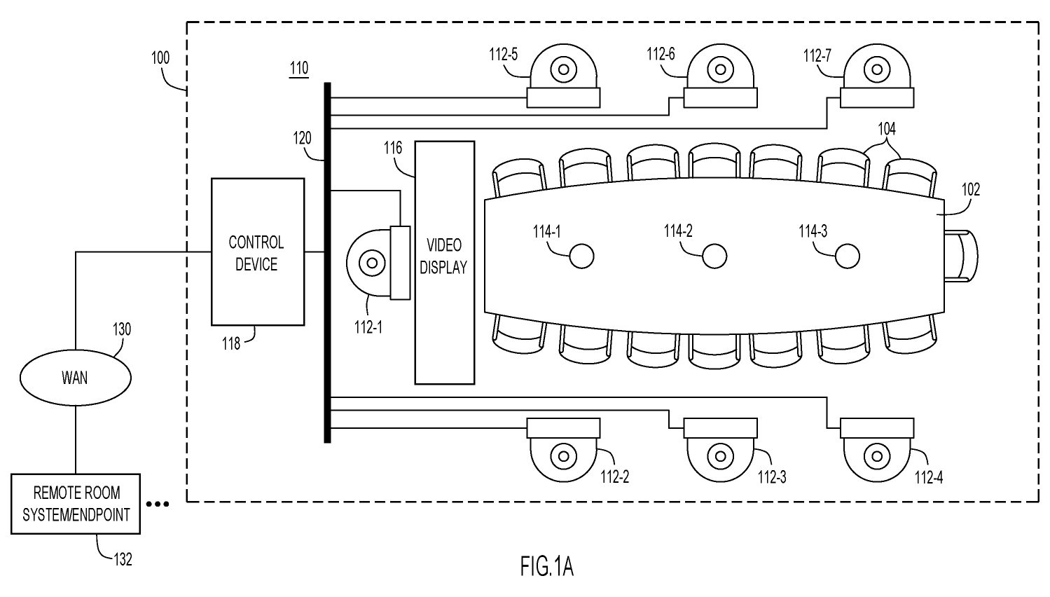

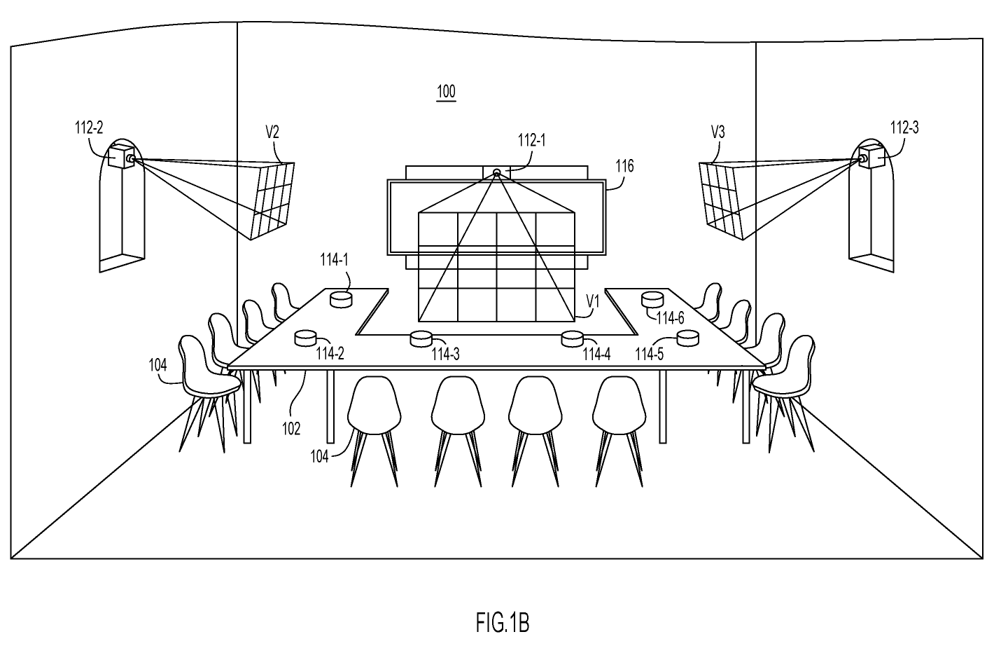

Reference is now made to FIG. 1A. FIG. 1A illustrates (a top view of) a video conference space 100 that includes a conference table 102 having a plurality of chairs 104 for participants. A video conference room system 110 is deployed in the video conference space to capture video (and audio) from participants in the video conference space 100 to be forwarded to one or more remote participant endpoints. The video conference room system 110 includes a plurality of video cameras 112-1, 112-2, 112-3, 112-4, 112-5, 112-6, and 112-7; a plurality of microphones 114-1, 114-2 and 114-3 at various positions on or around the conference table 102; at least one video display 116; and a (central) control device 118. The video display 116 may be useful in a large conference space (e.g., large board room) where it is desirable to show the face(s) of a speaker/speakers (who may be physically in the conference space). The control device 118 is also referred to as a “video codec” because it performs the various video encoding operations for sending out video to remote video conference room systems/endpoints and video decoding operations for received encoded video from remote video conference room systems/endpoints. The control device 118 also performs analysis and makes decisions as to which video stream/feed from among the video streams obtained from video cameras 112-1 to 112-7 to select to compose an outbound or output video stream. The control device 118 is also referred to herein as a “central control device”.

The number of video cameras, microphones and video displays in the video conference room system 110 may vary depending on the size of the video conference space 100, the size of the conference table 102, fidelity of the meeting experience desired, etc. Therefore, it is to be understood that the number of such components shown in FIG. 1A is by way of example only and not meant to be limiting.

The control device 118 may have a limited number of video data inputs (e.g., High-Definition Multi-Media Interface (HDMI) inputs) to which it can accept video from the video cameras 112-1 to 112-7. To make the video conference room system 110 more scalable, the control device 118 may communicate with one or more of the video cameras 112-1 to 112-7 by a local area network (LAN) 120 using video over Internet Protocol (video over IP) techniques.

The control device 118 sends outbound/output media (audio and video) streams via a wide area network (WAN) 130 to one or more remote video conference room systems/endpoints 132 and receives inbound media (audio and video) streams from the one or more remote video conference room systems/endpoints 132 via the WAN 130.

The microphones 114-1, 114-2 and 114-3 detect sound in the video conference space 100 and provide associated audio signals to the control device 118. In addition to providing audio to the remote video conference room systems/endpoints, the control device 118 can use the audio signals to estimate the spatial position of one or several speakers in the video conference space 100. In addition, the video cameras 112-1 to 112-7 are connected to the control device 118 in order to both control the video cameras and to provide video streams captured by the video cameras 112-1 to 112-7 to the control device 118. Further, the spatial positions of the video cameras are known/determined and otherwise stored in control device 118.

If all the video cameras 112-1 to 112-7 continuously stream their captured video to the control device 118, the processing capabilities of the control device 118 will be surpassed very quickly. Processing video streams from the video cameras employs memory, power, processing, etc. In one example, the control device 118 can process 2 or 3 streams simultaneously. Two or three camera views simultaneously usually suffice, either to switch between or to compose together into one output video stream. However, video conference spaces often have many more seating positions and could benefit from having many more camera views to offer to the far side / remote video conference room systems/endpoints.

In general, for video analysis, a full sensor field-of-view can maximize the room view, while for active video streaming, a cropped stream may be chosen to maximize quality. Even when video is being streamed, it is advantageous to have access to the full field of view for analysis. This means that each camera would need to generate two separate video streams: one low frame rate stream for analytics and one cropped high frame rate stream in a scenario where analysis of video streams is being performed. This can limit practical scalability of such a solution.

Traditionally, the control device 118 would receive video streams from all the video cameras in the space, and would apply facial recognition, position analysis, pose analysis, etc., from all streams, pick the best camera and perhaps crop a region out of the relevant/selected stream. This places a substantial processing burden on the control device 118.

With increasing numbers of video cameras in a video conference space, the processing resources of the control device 118 become the limiting scaling factor because it cannot receive, process, and analyze the media streams from all the video cameras simultaneously. A scalable method is presented herein to retrieve and analyze video from multiple cameras in a video conference space and present the best view (a single video stream or multiple video streams composed together) of the meeting participants, depending on the activity and/or who is speaking in the video conference space at that time. The control device 118 may select/compose the best view and send it as an output video stream to remote video conference systems/endpoints as well as to be presented on a video display in the video conference space, e.g., on video display 116.

Some currently available video cameras have more processing capabilities. It is therefore possible to put some of the processing burden on the video cameras to analyze captured video (e.g., for face detection, pose detection, etc.) as well as to crop the video stream they capture before sending it to the control device 118. Thus, those cameras can send only metadata to the control device 118, such as indications of whether a face/head was detected, who is the person associated with that face, and in which direction is the face/head pointing (pose), as well as detected objects (whiteboards, etc.).

It is also envisioned that one or more of the video cameras 112-1 to 112-7 may be less capable video cameras that have minimal processing capabilities. Such less capable video cameras are less expensive, and thus more of them can be deployed in a video conference space if cost is a concern. In this case, the processing capabilities of the control device 118 will be used to perform analysis of video captured by such less capable video cameras. However, even such less capable video cameras can be controlled to provide snapshots (still images) instead of a video stream.

The techniques and arrangements presented herein distribute compute operations between the control device 118 and the video cameras 112-1 to 112-7, depending on their processing capabilities. The amount of data that each video camera sends to the control device 118 can be managed, and in many cases, significantly reduced.

FIG. 1B illustrates a perspective view of an example physical arrangement of components of video conference room system 110 in a video conference space 100. Some components, such as the control device 118 of the video conference room system 110, are not shown in FIG. 1B, for simplicity. FIG. 1B shows the positioning of video cameras 112-1, 112-2 and 112-3, where video camera 112-1 sits on top of video display 116, whereas video cameras 112-2 and 112-3 are mounted on opposite walls. There are numerous microphones 114-1, 114-2, 114-3, 114-4, 114-5 and 114-6 positioned around the conference table 102. In the example of FIG. 1B, the conference table 102 is U-shaped. Chairs 104 are positioned around the conference table 102. FIG. 1B further shows that video camera 112-1 has a first view denoted V1 of the video conference space 100, video camera 112-2 has a second view denoted V2 in the video conference space 100 and video camera 112-3 has a third view denoted V3 in the video conference space 100. Using the techniques presented herein, the control device 118 (FIG. 1A) can exploit the different views of the video cameras in the conference room to develop a complete understanding of the activity in the video conference space, and thus select which one or more video cameras should be used for outgoing video from the video conference space 100.

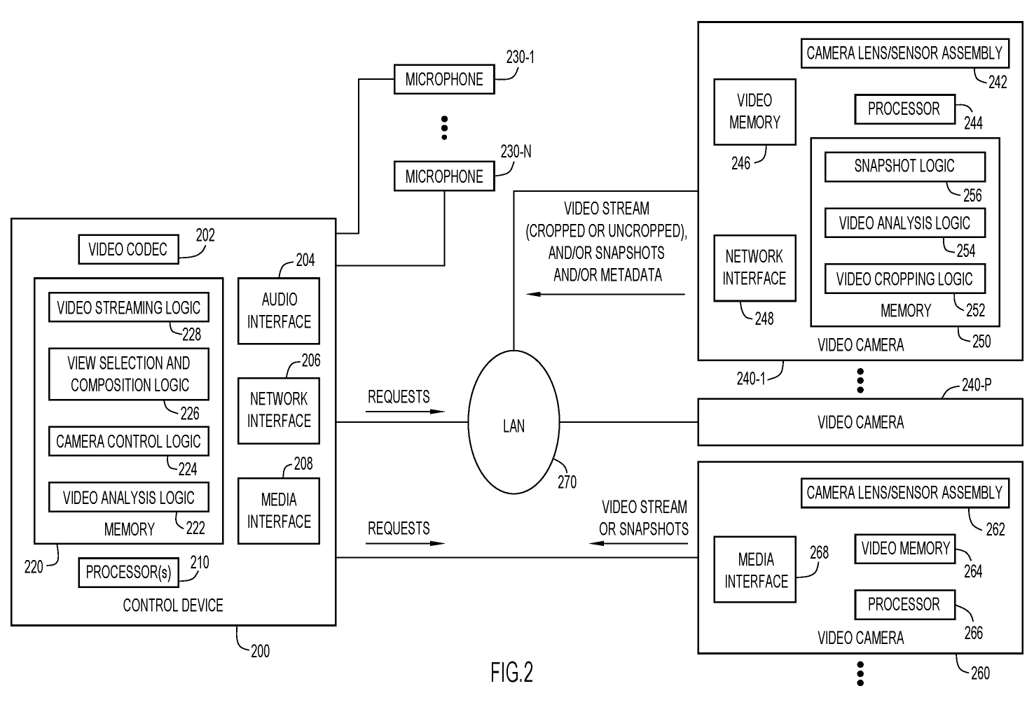

Reference is now made to FIG. 2, with continued reference to FIGS. 1A and 1B. In FIG. 2, a detailed block diagram of a control device 200 is shown that may serve as the control device 118 of the video conference room system 110. The control device 200 includes a video codec 202, an audio interface 204, a network interface 206, a media interface 208, one or more processors 210, and memory 220.

The video codec 202 performs encoding of video that has been selected and/or composed from one or more video cameras to be sent as an output video stream to one or more remote video conference room systems/endpoints, and to decode video that has been received from one or more remote video conference room systems/endpoints. While FIG. 2 shows the video codec 202 as a separate component (e.g., a dedicated integrated circuit) of the control device 200, it is also envisioned that the video codec 202 may be embodied by software instructions stored in memory 220 and executed by the one or more processors 210.

The audio interface 204 is, for example, an analog interface, a digital interface such as a Universal Serial Bus (USB) interface, or a network interface (to support audio over IP protocols) and is configured to receive audio from microphones 230-1 to 230-N shown in FIG. 2. The network interface 206 is, for example, one or more network interface cards, and it enables network communication with various devices, such as video cameras, via LAN 270. The media interface 208 is, for example, an HDMI interface port (and associated control logic) that can accept video data from a video camera, for example, as described below.

The one or more processors 210 of the control device may take the form of one or more microprocessors, one or more microcontrollers, one or more application specific integrated circuits, etc. System-on-Chip (SOC) devices may be used for the processors 210 as well as for one or more other components, such as the video codec 202. The memory 220 may store data associated with audio and video that the control device 200 processes. In addition, the memory 220 stores software instructions for various functions that the control device 200 performs according to the embodiments presented herein. Specifically, the memory 220 stores software instructions for video analysis logic 222, camera control logic 224, view selection and composition logic 226 and video streaming logic 228. When executed by the one or more processors 210, the software instructions for the video analysis logic 222 enable the control device 200 to analyze a video stream received from one or more video cameras to perform facial recognition of a person, determine pose of a person, detect a gesture of a person, etc. The video analysis logic 222 may use machine-learning (ML) or artificial intelligence (AI) techniques for face detection, pose detection, etc. The camera control logic 224 enables the control device 200 to issue controls and requests to one or more video cameras, such as to request one or more (full field of view) snapshots (still image/video frame) of a scene captured by a video camera, request one or more video cameras to digitally crop a video stream to a particular region and send the cropped video stream to the control device 200, control a video camera to change its field of view (e.g., optically pan, tilt or zoom) if the video camera has such capability, etc. Requesting snapshots in sequence adapts easily to potentially fluctuating processing times for video analysis because no video decode context needs to be kept between I-frames (also called Key-frames or Intra-frames) for each video camera. As such, this scales smoothly to a large number of video cameras.

The video selection and composition logic 226 enables the control device 200 to select a video stream from one or more cameras to be used to decide on the area of the image/view to show and thus form a composed output video stream that is to be sent to one or more remote video conference room systems/endpoints (as well as to display locally in the video conference room, if desired). The composed video stream may consist of one video stream from one camera (cropped to a particular region to best show a speaking participant, for example, or not cropped) or it may be a combination of two (or more) video streams to, for example, show (in a single screen/frame) two or more participants interacting with each other during a video conference session. The video selection and composition logic 226 may also select one or more views and send them as separate video streams, to be composed on the receiving side (by a remote endpoint). The view selection and composition logic 226 may make its video stream selection based on data derived from the video analysis logic 222, from audio captured by the microphones 230-1 to 230-N, and from metadata and snapshots obtained from one or more video cameras.

The video streaming logic 228 enables the control device 200 to prepare an output video stream based on output from the view selection and composition logic 226. Moreover, execution of the video streaming logic 228 may be separate and independent from execution of the video analysis logic 222, camera control logic 224 and view selection and composition logic 226. In other words, the control device 200 may have two processing pipelines. The control device 200 may have a first processing pipeline that generates a selected or composed video stream (produced by the view selection and composition logic 226) and prepares it to send out to the remote video conference room systems/endpoints. The control device 200 may have a second processing pipeline to take in snapshots from video cameras and perform video analysis on the snapshots to determine the situation in the video conference room across the views of the video cameras (to build a data structure that represents activity in the room (people standing up, leaving, etc.). The second processing pipeline may also be used to make a decision to change to a different video stream to be sent to the remote video conference room systems/endpoints (e.g., to show a different part of the video conference space to the far end). The control device 200 may use a first one or more processors for the first processing pipeline and a second one or more processors for the second processing pipeline.

FIG. 2 also shows more details of video cameras 240-1 to 240-P that have built-in processing capabilities as well as a detailed block diagram of video camera 260 that has minimal processing capabilities. Video cameras 240-1 to 240-P include a camera lens/sensor assembly 242, a processor 244, video memory 246, a network interface 248, and memory 250. The memory 250 includes software instructions for video cropping logic 252, software instructions for video analysis logic 254 and software instructions for snapshot logic 256. The camera lens/sensor assembly 242 captures a scene and outputs raw video data that may be stored in video memory 246. The processor 244 may be a microprocessor or microcontroller and executes instructions stored in memory 250 and based on raw video data stored in video memory 246. The network interface 248 may take the form of a network interface card (wired or wireless), and it sends network packets carrying metadata or video data to the control device 200, as well as receives from the control device 200 controls and requests that are sent to the associated video camera.

The processor 244 responds to controls and requests received from the control device 200 to determine whether to invoke operations of the video cropping logic 252 and/or the video analysis logic 254, as well as whether to change a field of view of the camera lens/sensor assembly 242, to send a captured video stream via network interface 248 to the control device 200 or to stop sending a captured video stream to the control device.

The software instructions for the video cropping logic 252 may, when executed by the processor 244, cause the processor 244 to digitally crop video to a particular sub-region of a captured scene by the video camera. For example, the control device 200 may send a request to crop the video of a captured scene to encompass a detected person and some surrounding area around that person (that may or may not include one or more other persons in the captured scene). In another variation, the processor 244 may determine to crop the video stream to a particular region based on an analysis by the video analysis logic 254. To this end, the video analysis logic 254, when executed by the processor 244, causes the processor 244 to perform facial recognition of a detected person, determine pose of a person, detect a gesture of a person, using ML or AI techniques, etc., similar to the video analysis logic 222 of the control device 200. The video analysis logic 254 may produce metadata that describes the captured video in terms of identity of a person, pose/orientation of a person, detected gesture of a person, etc., and this metadata (associated with timestamp information) may be sent to the control device 200. The control device 200 may instruct the video camera to perform video analysis and send back metadata resulting from the video analysis.

The snapshot logic 256 enables the processor to generate a snapshot (still image / video frame) at each of one or more time instants for a captured scene and to send the one or more snapshots to the control device 200. The snapshot logic 256 may be invoked in response to a request that the control device 200 sends to the video camera, or based on a determination to capture a snapshot by the processor 244 of the video camera.

As explained above, it is envisioned that one or more video cameras deployed in a video conference room system may be lesser capable cameras. An example of such a lesser capable camera is video camera 260 shown in FIG. 2. Video camera 260 includes a camera lens/sensor assembly 262, video memory 264, a processor 266 and a media interface 268. The processor 266 may take the form of a microcontroller that performs basic functions to take raw video data from video memory 264 and format it to send via media interface 268, e.g., an HDMI interface, to the control device 200. Moreover, the processor 266 may be configured to respond to requests from the control device 200, such as to send one or more snapshots of video, stop sending video, start sending video, etc.

The processors 210, processor 244 and processor 266 shown in FIG. 2 may be one or more hardware processors configured to execute various tasks, operations, and/or functions for the control device 200, video cameras 240-1 to 240-P and video camera 260, respectively. These processors (e.g., a hardware processor) can execute any type of instructions associated with data to achieve the operations detailed herein. Any of the potential processing elements, microprocessors, image processor, digital signal processor, artificial intelligence (AI)-based processor, graphics processors, video encoders/decoders, logic, and/or machines described herein can be construed as being encompassed within the broad term 'processor'. The processors can transform an element or an article (e.g., data, information) from one state or thing to another state or thing.

Any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory discussed herein may be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

In certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an application specific integrated circuit (ASIC), digital signal processing (DSP) instructions, software [potentially inclusive of object code and source code], etc.) for execution by one or more processor(s), and/or other similar machine, etc. Generally, memory 220 and memory 250 can store data, software, code, instructions (e.g., processor instructions), logic, parameters, combinations thereof, and/or the like used for operations described herein. These memories can store data, software, code, instructions (e.g., processor instructions), logic, parameters, combinations thereof, or the like that are executed to carry out operations in accordance with teachings of the present disclosure.

To initially determine where the speaking participant is located in the video conference space, the control device 200 may use audio detected by the microphones. The positions of the video cameras in the room are known (and configured into the control device). Using audio positioning techniques known in the art, the control device 200 can determine where to expect the head of the speaker to be located in the video conference space. Two or more video cameras may have overlapping views, and thus, multiple video cameras may have views of the speaking participants, but some of those video cameras may have an obstructed view of the speaker, a bad angle or bad perspective of the speaker, etc.

The control device 200 may request snapshots from all the connected video cameras. From those snapshots, the control device 200 may determine if there is a video camera that captures the face of the speaker with a good angle/perspective, that would be suitable to show in an output video stream. Once that particular video camera is identified, the control device 200 can include the video stream from that particular camera in the output video for the video conference space. Thus, the control device 200 can request all or some subset of the video cameras to indicate what they “see” of a particular speaker, what is the direction of that speaker’s head with respect to that video camera (pose), and with facial recognition, the identity of the person the video camera is capturing. The snapshots can be provided to the video analysis logic 222 running on the control device 200 to enable the control device to determine an understanding of what each video camera is capturing, and in so doing enable the control device 200 to build an understanding of the activity in the video conference space and select the best video stream (from the associated video camera) to use for a specific scenario occurring in the video conference space.

In some situations, such as when there are rapid exchanges between participants in a meeting room, the control device 200 may detect the occurrence of such an exchange (from audio and video) and then select two or more video cameras capturing the two or more participants involved in the exchange, and obtain cropped views that can be composed into a side-by-side combined video stream. This can be more desirable than switching between two or more video cameras to show two or more speakers who may be engaged in an animated discussion. In some cases, the control device 200 may detect an active speaker looking at a meeting participant who is acknowledging the active speaker by nodding to answer questions, etc., but not actually speaking. These techniques can be employed to support switching between video cameras to show the active speaker and the meeting participant who is nodding or making some other gesture (but not necessarily speaking) back to the active speaker that should be captured in the output video stream.

The computation burden of the control device can be reduced based on the level of built-in processing of the video cameras employed in the video conference room system.

In a first arrangement, the control device 200 requests the video cameras currently not selected for the final layout to send snapshots to the central unit instead of a video stream. The control device 200 saves computation resources by having fewer video streams to process, and can request snapshots from video cameras at intervals selected to match its processing capabilities. Using these snapshots, the control device 200 can analyze the scene represented by the snapshots to determine, for example, person identity, body pose, person position and gesture. Based on the analysis results of the snapshots, the control device 200 may decide to crop a sub-region of interest from the received video streams for further processing, and then request a video camera to send a cropped version of the video stream to the control device 200. The control device 200 may reduce bandwidth consumed from a particular video camera that sends a cropped video stream, and also reduce its computation burden by not having to decode a full frame rate video stream from that video camera.

The control device 200 may request/control a lesser capable video camera, such as video camera 260, to capture an uncropped image (for a frame) as a snapshot and send it to the control device 200. The control device 200 may send a request one snapshot at a time so that it requests a new snapshot when it is ready to analyze another snapshot.

In a second arrangement, a video camera with built-in processing capabilities, such as one or more of the video cameras 240-1 to 240-P, analyzes captured video representing its view of the video conference space using, for example with ML/AI methods for body identity (who), pose (which direction is the person facing, standing/sitting), and position (where is the person), objects that are in view and the locations of those objects (whiteboard, chairs, microphones, etc.) as well as any detected gesture of the person, and sends the analysis results (metadata) to the control device 200. The control device 200 saves computation resources by receiving the analysis results (metadata) instead of having to analyze the video stream or snapshots from the video camera.

In a third arrangement, as in the second arrangement, each video camera analyzes the video stream of its view and, based on the analysis result, selects a sub-region of interest and generates a cropped video stream of only the sub-region of interest (e.g., crop of a head or upper body of a person) to provide to the control device 200. The video camera can still make its entire field of view available as in the first arrangement and/or provide analysis results (metadata) as in the second arrangement to allow the central device 200 to make decisions on which video camera streams to use. The central device 200 saves computation resources by receiving lower data video streams, saves the processing for cropping the video, and may save analysis processing efforts. In a variation, the central device 200 could obtain one or more snapshots from a given video camera, analyze the snapshots, identify a sub-region of interest in the one or more snapshots, then request the video camera to generate a cropped video stream to focus on a sub-region of interest identified based on the snapshots obtained from the given video camera, and request that the given video camera send that cropped video stream to the control device 200.

In general, it is advantageous to keep the decision making operations centralized at the control device 200 to provide a more consistent experience, and use the video cameras as video sources.

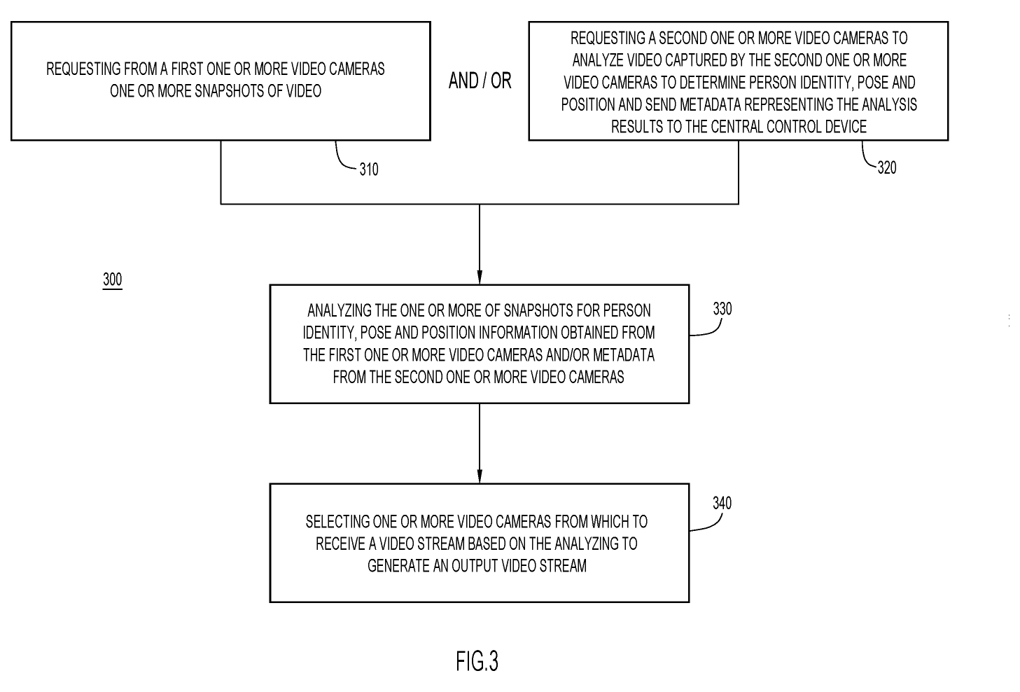

Turning now to FIG. 3, with continued reference to FIGS. 1A, 1B and 2, a flow chart is shown depicting, at a high-level, a method 300 according to an example embodiment. To support the method 300, a plurality of video cameras are deployed and configured to capture video with different views in a video conference space during a video conference session, as shown in FIG. 1A and 1B. A central control device is provided that is configured to be in communication with the plurality of video cameras.

The method 300 involves, for a most general case, at step 310, either the central control device requesting from a first one or more video cameras of the plurality of video cameras, one or more snapshots of video for an associated view of the first one or more video cameras, or, at step 320, the central control device requesting a second one or more video cameras of the plurality of video cameras to analyze video captured by the second one or more video cameras to determine person identity, pose and position and send metadata representing the analysis results to the central control device. In some scenarios, it is envisioned that both step 310 and step 320 are performed, but again, in the most general case, either of the two steps are performed.

Step 330 involves the central control device analyzing the one or more of snapshots for person identity, pose and position information obtained from the first one or more video cameras and/or the metadata from the second one or more video cameras. Again, for the case when both steps 310 and 320 are performed, then the central control device analyzes the one or more snapshots from the first one or more video cameras and the metadata from the second one or more video cameras.

Step 340 involves the central control device selecting one or more video cameras from which to receive a video stream based on the analyzing to generate an output video stream. The central control device is configured to send the output video stream to one or more remote video conference room systems or endpoints that are connected to the video conference session.

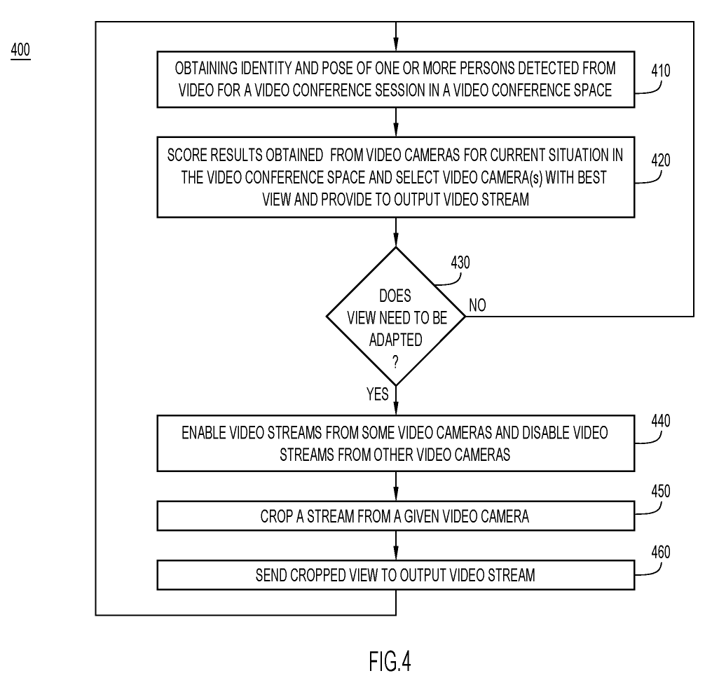

Turning now to FIG. 4, a flow chart is shown for a more detailed sequence of operations of a process 400 that may be performed in connection with the embodiments presented herein. The process 400 depicts one example of how off-loading strategies can be applied for a central control device in a video conference room system to select the best view of the meeting participants. These off-loading strategies are not limited to this example scenario and can be applied to any other use case.

The process 400 involves, at step 410, obtaining identity and pose of one or more persons detected from video for a video conference session in a video conference space. This may involve one or both of two solutions/techniques. A first technique involves determining the identity and pose of one or more persons using snapshots provided by the video cameras to the central control device. The central control device requests snapshots from those one or more video cameras that, based on the spatial location and video camera characteristics, may be able to provide a view of the position where the speaking persons have been detected. The central control device may use audio detected by the microphones in the video conference space to assist in determining which one or more video cameras of the plurality of video cameras in the space should be selected for requesting snapshots. The central control device analyzes the snapshots using AI/ML or other techniques that can determine the identity of the persons in the snapshots and their body pose.

The second technique involves one or more video cameras (that have processing capability) analyzing continuously, or upon request by the central control device, captured video to generate and send to the central control device metadata indicating identity of detected persons, body pose of the persons and/or position relative to the video camera.

At step 420, the central control device scores the results obtained from the video cameras (in step 410) for the current situation in the video conference space. That is, the analysis results are ranked based on behavioral preferences associated with the speaking person in the room, the number of speaking persons in an exchange with each other, etc. The outcome of the scoring is an ordered list of camera views. The central control device determines which camera view is the best view of the detected speaker and other persons, and selects either a single camera view or multiple camera views composed together, from which to provide an output video stream.

At 430, the central control device determines whether the currently generated video stream is a sufficiently good representation of the situation in the video conference space or if the view and composition or layout should be adapted. If the central control device determines that the view should be adapted, it will generate a new view layout as explained below. The criteria that the central control device may use to assess whether the current generated output video stream is a good representation of the situation may include determining when the speaker(s) is/are visible. Another example involving pose and object detection is when a presenter is detected near a whiteboard, in which case the view should include both the speaker and the whiteboard. The case of detecting a whiteboard next to a presenter is an interesting case because the central control device may decide to frame the speaker and the whiteboard in a single frame, or to send the speaker and the whiteboard in separate frames, or even as separate video streams.

According to the result of the determination made at step 430, at step 440, the central control device may turn off (disable) video streaming from some cameras and turn on (enable) video streaming from other cameras, taking into consideration a maximum number of active streams that the central control device can handle. Thus, to operate within the processing limits of the central control device, the central control device may switch off video from some video cameras and enable video from other video cameras.

At step 450, the central control device determines that for a given desired layout in the output video stream, video from one or more cameras is to be digitally cropped (to focus on a sub-region of interest in the camera’s field of view). The digital cropping can be done in one of two ways. In a first arrangement, the central control device requests a video stream from the video camera, and the video camera sends an uncropped stream of the entire field-of-view of the camera. The central control device then applies a digital crop to the received video stream to show only the relevant sub-region of the field of view that has been selected for the layout. In a second arrangement, the central control device requests a video stream from the video camera, identifies a sub-region of interest and specifies to the video camera the sub-region of the field of view to be used for the output video stream. The central control device may specify to the video camera the sub-region of interest to which to crop by specifying a rectangle with corner/border positions, such as left/right/top/bottom, or potentially in a percentage of a width/height. Accordingly, the video camera will digitally crop the video stream and send a (cropped) video stream of only the relevant sub-region of the field of view. This reduces the bandwidth by reducing the number of pixels to transmit the cropped video stream.

Still referring to FIG. 4, at step 460, the resulting cropped video stream is sent to the output video stream, either as the only video content in the output video stream, or as part of a composed stream from multiple cropped video streams from one or more other video cameras. It is also possible that a cropped video stream may be combined with an uncropped video stream, if desired. The use of cropped video streams allows reducing bandwidth as compared to an uncropped video stream, and using the bandwidth better (quality/information is increased) since the more interesting part of the video is sent for that part of the video conference session.

The process 400 may be triggered by various events, such as: when speaker position detection changes, when a timer event changes the view at certain intervals, when a previously undetected persons gets detected in the video conference space, when the detected situation changes in the video conference space, such as moving from a one-to-one discussion in the video conference space to applause. Moreover, the central control device can continuously analyze active video camera streams for changes in the video conference space. Thus, after step 450, the process reverts to step 410.

At any time, the central processing device can request snapshots from the video cameras that are not sending video streams or from video cameras sending cropped video to generate analysis results can be used to re-evaluate the results at step 420.

### Example Use Case

One use case is to manage the size and the usage of the video stream from a video camera to the central control device. The central control device can instruct a particular video camera to use a higher resolution video stream but cropped to a smaller sub-region of interest compared to a resolution that could be transported by the video camera to the central control device if the entire field of view is sent in the video stream. Alternatively, the central control device can reduce the amount of data (bit rate) to be transmitted from the video camera to the central control device by keeping the same video resolution and quality. In cases when the central control device instructs a video camera to stream video that has been digitally zoomed (cropped), it is beneficial to request still images for analysis from the video cameras that are sending a video stream so that the field of view available for analysis is maximized.

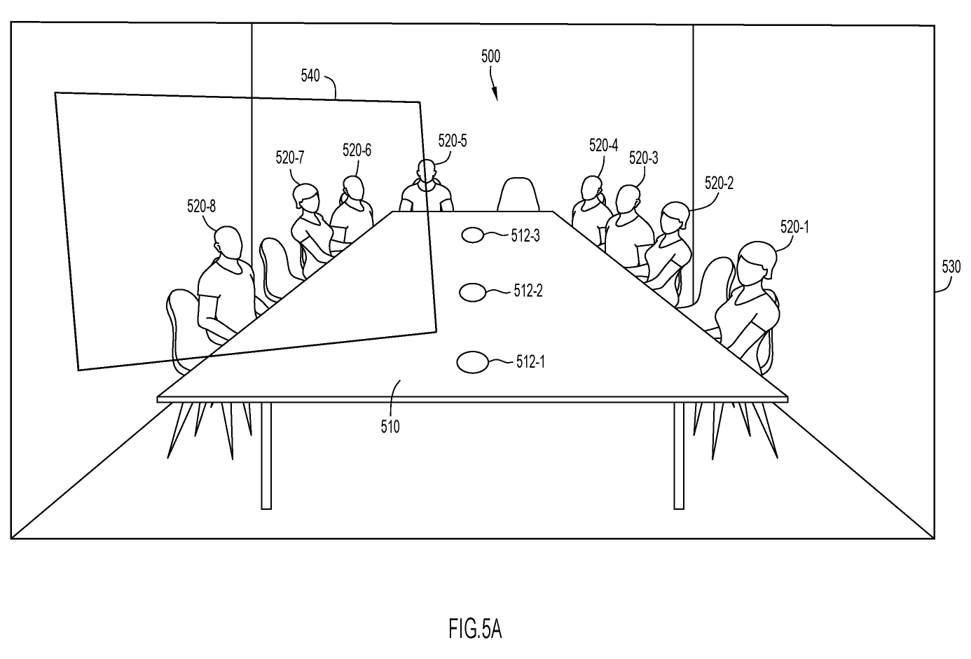

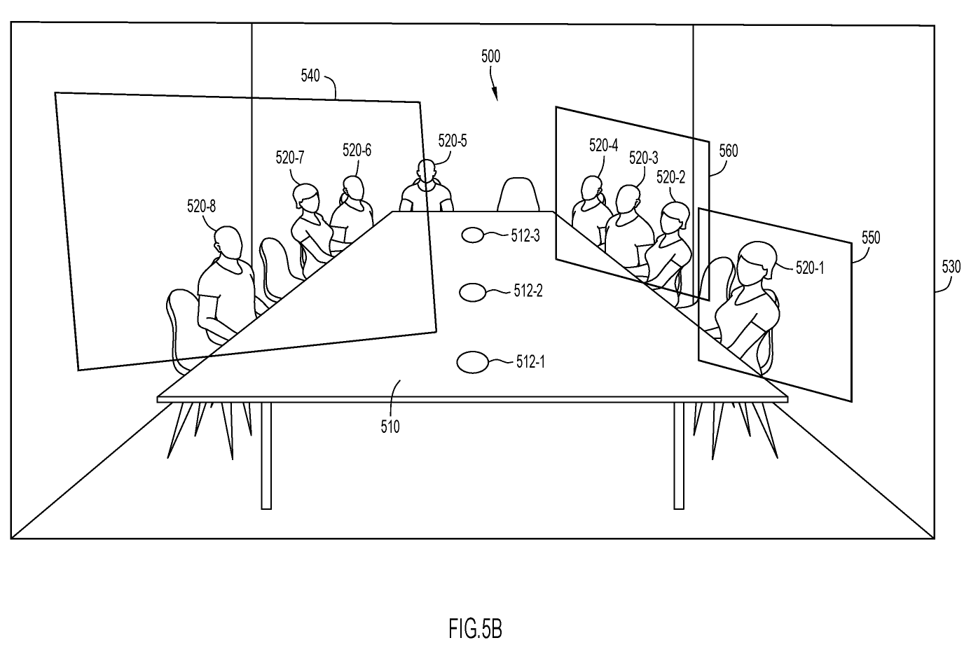

FIG. 5A shows an example of a situation in which a video stream from a video camera is cropped. The figure shows a video conference space 500 having a conference table 510 with numerous seating positions (not all of which are occupied at this time) and several meeting participants 520-1, 520-2, 520-3, 520-4, 520-5, 520-6, 520-7 and 520-8 around the conference table 510. There are microphones 512-1, 512-2 and 512-3 arranged on the conference table 510. A first video camera (not shown) positioned at one end of the video conference space 500 captures a field of view 530 of the entire conference table as shown in FIG. 5A. Through the use of the techniques presented herein, at this point in time, participant 520-8 is determined to be speaking, and participants 520-6 and 520-7 had been previously speaking. Therefore, the central control device determines to instruct the first video camera providing the field of view 530 to crop its video stream, as shown by the rectangle 540, to include a zoomed-in view of speaking participant 520-8 as well as participants 520-6 and 520-7 in the cropped video stream. The rectangle 540 marks the sub-region (of the full field of view 530) that is used for video streaming while analysis can be done on the full field of view 530.

While the cropped view represented by rectangle 540 is being provided to the output video stream to be sent from the video conference space 500, the central control device may request snapshots from video cameras that have a view of the other side of the conference table 510. FIG. 5B shows a field of view 550 for a second video camera in the video conference space and a field of view 560 for a third video camera in the video conference space. The central control device may obtain snapshots for field of view 550 and field of view 560, and that allows for reduced bandwidth of video to the central control device but still allows the central control device to analyze the content of the snapshots for identity, pose and position. Alternatively, the central control device may instruct the second video camera and the third video camera that have the field of view 550 and field of view 560, respectively, to analyze the video they each capture and send metadata indicating identity, pose and position for what is detected within their respective fields of view. Using either or both of the snapshots and the metadata, at some point in time later, the central control device may determine that participant 520-3 is an active speaker, and the central control device may instruct the third video camera with field of view 560 to generate a cropped view of participant 520-3 and that cropped view is provided to the output video stream for the video conference space 500, replacing the cropped view associated with rectangle 540 or in addition to the cropped view (in a side-by-side composed video stream).

In summary, the central control device for a video conference room system has limits with respect to receiving and analyzing video streams from video cameras in the video conference room. Methods are provided herein to utilize a large number of video cameras in a video conference space with a resource limited central processor device by decentralizing part of the video analysis and processing onto the video cameras. These techniques allow the central control device to enable a few video streams from video cameras within the processing limits of the central control device, while other content captured by other video cameras can be considered by obtaining the image analysis results performed by those video cameras or by periodically (or on demand) retrieving and analyzing snapshot/still images from those other video cameras. In this way, a virtually unlimited number of video cameras can be used to provide a video conference experience using a central control device with limited resources because the number of video cameras can exceed limits for total pixels per second throughput, number of simultaneous decodable streams and AI/ML image processing capabilities of the central control device. The frequency and resolution of retrieving the still images can furthermore be adapted to the capability of the central control device to process and analyze the data.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but does not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

In summary, the techniques present herein relate to a system, method, apparatus and non-transitory computer readable storage media configured to perform aspects of the subject matter presented herein. In one form, a system includes: a plurality of video cameras configured to capture video with different views in a video conference space during a video conference session; and a central control device configured to be in communication with the plurality of video cameras, and to perform operations including: requesting from a first one or more video cameras one or more snapshots of video; requesting a second one or more video cameras to analyze video captured by the second one or more video cameras to determine person identity, pose and position and send metadata representing analysis results to the central control device; analyzing the one or more of snapshots for person identity, pose and position information obtained from the first one or more video cameras or the metadata from the second one or more video cameras; and selecting one or more video cameras from which to receive a video stream based on the analyzing to generate an output video stream.

In one form, the central control device is configured to send the output video stream to one or more remote video conference room systems or endpoints that are connected to the video conference session.

In another form, the central control device is configured to request the one or more snapshots of video from the first one or more video cameras at time intervals during the video conference session based on processing capabilities of the central control device.

In some aspects, each of the second one or more video cameras are configured to: analyze captured video of its respective view; select a region of interest of the captured video to generate a cropped video stream; and send the cropped video stream of only the region of interest to the central control device.

In some aspects, the central control device is configured to request the one or more snapshots from the first one or more video cameras based on spatial location of the first one or more video cameras, and the central control device analyzes the one or more snapshots to obtain body identity, pose and position information.

In some embodiments, the second one or more video cameras are configured to continuously analyze video to provide metadata of body identity, pose and position of persons detected, of one or more objects detected, to the central control device.

In some embodiments, the central control device is configured to disable video from some of the plurality of video cameras and enable video from others of the plurality of video cameras, based on a maximum number of active video streams.

In yet other embodiments, the central control device, upon determining that a view of a particular video camera of the plurality of video cameras should be cropped, is configured to perform operations including: requesting a video stream from the particular video camera and apply a digital crop for a sub-region of field of view of the particular video camera; or sending to the particular video camera a request that specifies a sub-region of the field of view for the particular video camera to crop and send back to the central control device a cropped video stream for the sub-region.

In some forms, the particular video camera is one of the first one or more video cameras, and the central control device is configured to identify the sub-region based on one or more snapshots obtained from the particular video camera.

In some forms, the central control device is configured to request from all of the plurality of video cameras one or more snapshots of video for analysis.

A method is also presented herein, the method including: capturing video with a plurality of video cameras with different views in a video conference space during a video conference session; and at a central control device that is in communication with the plurality of video cameras: requesting from a first one or more video cameras one or more snapshots of video; requesting a second one or more video cameras to analyze video captured by the second one or more video cameras to determine person identity, pose and position and send metadata representing analysis results to the central control device; analyzing the one or more of snapshots for person identity, pose and position information obtained from the first one or more video cameras or the metadata from the second one or more video cameras; and selecting one or more video cameras from which to receive a video stream based on the analyzing to generate an output video stream.

In some forms, the method further includes: sending the output video stream to one or more remote video conference room systems or endpoints that are connected to the video conference session.

In some forms, the method includes, with each of the second one or more video cameras: analyzing captured video of its respective view; selecting a region of interest of the captured video to generate a cropped video stream; and sending the cropped video stream of only the region of interest to the central control device.

In one embodiment, requesting one or more snapshots includes requesting from all of the plurality of video cameras one or more snapshots of video for analysis.

In some forms, the method further includes, upon determining that a view of a particular video camera of the plurality of video cameras should be cropped, the central control device: requesting a video stream from the particular video camera and applying a digital crop for a sub-region of field of view of the particular video camera; or sending to the particular video camera a request that specifies a sub-region of the field of view for the particular video camera to crop and send back to the central control device a cropped video stream for the sub-region.

In some aspects, an apparatus is provided that includes: a network interface configured to enable network communication with a plurality of video cameras configured to capture video with different views in a video conference space during a video conference session; a memory; and a processor configured to execute instructions stored in the memory to perform operations including: requesting from a first one or more video cameras one or more snapshots of video; requesting a second one or more video cameras to analyze video captured by the second one or more video cameras to determine person identity, pose and position and send metadata representing analysis results to the apparatus; analyzing the one or more of snapshots for person identity, pose and position information obtained from the first one or more video cameras or the metadata from the second one or more video cameras; and selecting one or more video cameras from which to receive a video stream based on the analyzing to generate an output video stream.

In some embodiments, the processor is configured to request the one or more snapshots from the first one or more video cameras based on spatial location of the first one or more video cameras, and to analyze the one or more snapshots to obtain body identity, pose and position information.

In some embodiments, the processor, upon determining that a view of a particular video camera of the plurality of video cameras should be cropped, is configured to perform operations including: requesting a video stream from the particular video camera and apply a digital crop for a sub-region of field of view of the particular video camera; or sending to the particular video camera a request that specifies a sub-region of the field of view for the particular video camera to crop and send back to the apparatus a cropped video stream for the sub-region.

In some embodiments, the processor is configured to request from all of the plurality of video cameras one or more snapshots of video for analysis.

In some forms, the processor is configured to disable video from some of the plurality of video cameras and enable video from others of the plurality of video cameras, based on a maximum number of active video streams.

In still another form, one or more non-transitory computer readable storage media are provided, encoded with instructions that, when executed by a processor of a central control device that is in communication with a plurality of video cameras that capture video with different views in a video conference space during a video conference session, cause the processor to perform operations including: requesting from a first one or more video cameras one or more snapshots of video; requesting a second one or more video cameras to analyze video captured by the second one or more video cameras to determine person identity, pose and position and send metadata representing analysis results to the central control device; analyzing the one or more of snapshots for person identity, pose and position information obtained from the first one or more video cameras or the metadata from the second one or more video cameras; and selecting one or more video cameras from which to receive a video stream based on the analyzing to generate an output video stream.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source, and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', ‘and/or’ variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A system comprising:
a plurality of video cameras configured to capture video with different views in a video conference space during a video conference session; and
a central control device configured to be in communication with the plurality of video cameras, and to perform operations including:
requesting from a first one or more video cameras one or more snapshots of video;
requesting a second one or more video cameras to analyze video captured by the second one or more video cameras to determine person identity, pose and position and send metadata representing analysis results to the central control device;
analyzing the one or more of snapshots for person identity, pose and position information obtained from the first one or more video cameras or the metadata from the second one or more video cameras; and
selecting one or more video cameras from which to receive a video stream based on the analyzing to generate an output video stream.

2. The system of claim 1, wherein the central control device is configured to send the output video stream to one or more remote video conference room systems or endpoints that are connected to the video conference session.

3. The system of claim 1, where the central control device is configured to request the one or more snapshots of video from the first one or more video cameras at time intervals during the video conference session based on processing capabilities of the central control device.

4. The system of claim 1, wherein each of the second one or more video cameras are configured to:
analyze captured video of its respective view;
select a region of interest of the captured video to generate a cropped video stream; and
send the cropped video stream of only the region of interest to the central control device.

5. The system of claim 1, wherein the central control device is configured to request the one or more snapshots from the first one or more video cameras based on spatial location of the first one or more video cameras, and the central control device analyzes the one or more snapshots to obtain body identity, pose and position information.

6. The system of claim 1, wherein the second one or more video cameras are configured to continuously analyze video to provide metadata of body identity, pose and position of persons detected, of one or more objects detected, to the central control device.

7. The system of claim 1, wherein the central control device is configured to disable video from some of the plurality of video cameras and enable video from others of the plurality of video cameras, based on a maximum number of active video streams.

8. The system of claim 1, wherein the central control device, upon determining that a view of a particular video camera of the plurality of video cameras should be cropped, is configured to perform operations including:
requesting a video stream from the particular video camera and apply a digital crop for a sub-region of field of view of the particular video camera; or
sending to the particular video camera a request that specifies a sub-region of the field of view for the particular video camera to crop and send back to the central control device a cropped video stream for the sub-region.

9. The system of claim 8, wherein the particular video camera is one of the first one or more video cameras, and the central control device is configured to identify the sub-region based on one or more snapshots obtained from the particular video camera.

10. The system of claim 1, wherein the central control device is configured to request from all of the plurality of video cameras one or more snapshots of video for analysis.

11. A method comprising:
capturing video with a plurality of video cameras with different views in a video conference space during a video conference session; and
at a central control device that is in communication with the plurality of video cameras:
requesting from a first one or more video cameras one or more snapshots of video;
requesting a second one or more video cameras to analyze video captured by the second one or more video cameras to determine person identity, pose and position and send metadata representing analysis results to the central control device;
analyzing the one or more of snapshots for person identity, pose and position information obtained from the first one or more video cameras or the metadata from the second one or more video cameras; and
selecting one or more video cameras from which to receive a video stream based on the analyzing to generate an output video stream.

12. The method of claim 11, further comprising:
sending the output video stream to one or more remote video conference room systems or endpoints that are connected to the video conference session.

13. The method of claim 11, further comprising, with each of the second one or more video cameras:
analyzing captured video of its respective view;
selecting a region of interest of the captured video to generate a cropped video stream; and
sending the cropped video stream of only the region of interest to the central control device.

14. The method of claim 11, wherein requesting one or more snapshots includes requesting from all of the plurality of video cameras one or more snapshots of video for analysis.

15. The method of claim 11, further comprising, upon determining that a view of a particular video camera of the plurality of video cameras should be cropped, the central control device:
requesting a video stream from the particular video camera and applying a digital crop for a sub-region of field of view of the particular video camera; or
sending to the particular video camera a request that specifies a sub-region of the field of view for the particular video camera to crop and send back to the central control device a cropped video stream for the sub-region.

16. An apparatus comprising:
a network interface configured to enable network communication with a plurality of video cameras configured to capture video with different views in a video conference space during a video conference session;
a memory; and
a processor configured to execute instructions stored in the memory to perform operations including:
requesting from a first one or more video cameras one or more snapshots of video;
requesting a second one or more video cameras to analyze video captured by the second one or more video cameras to determine person identity, pose and position and send metadata representing analysis results to the apparatus;
analyzing the one or more of snapshots for person identity, pose and position information obtained from the first one or more video cameras or the metadata from the second one or more video cameras; and
selecting one or more video cameras from which to receive a video stream based on the analyzing to generate an output video stream.

17. The apparatus of claim 16, wherein the processor is configured to request the one or more snapshots from the first one or more video cameras based on spatial location of the first one or more video cameras, and to analyze the one or more snapshots to obtain body identity, pose and position information.

18. The apparatus of claim 16, wherein the processor, upon determining that a view of a particular video camera of the plurality of video cameras should be cropped, is configured to perform operations including:
requesting a video stream from the particular video camera and apply a digital crop for a sub-region of field of view of the particular video camera; or
sending to the particular video camera a request that specifies a sub-region of the field of view for the particular video camera to crop and send back to the apparatus a cropped video stream for the sub-region.

19. The apparatus of claim 16, wherein the processor is configured to request from all of the plurality of video cameras one or more snapshots of video for analysis.

20. The apparatus of claim 16, wherein the processor is configured to disable video from some of the plurality of video cameras and enable video from others of the plurality of video cameras, based on a maximum number of active video streams.
